(19) United States
(12) Patent Application Publication
(10) Pub. No.: US 2010/0258256 A1
(43) Pub. Date: Oct. 14, 2010

(54) SUNSHADE ASSEMBLY FOR AN AUTOMOBILE

(75) Inventor: Paul Lin, Tainan Hsien (TW)

Correspondence Address: REED SMITH LLP, P.O. BOX 488, PITTSBURGH, PA, 15230-0488, US

(73) Assignee: MACAUTO INDUSTRIAL CO., LTD., Tainan Hsien (TW)

(21) Appl. No.: 12/814,551

(22) Filed: Jun. 14, 2010

(30) Foreign Application Priority Data
Apr. 13, 2009 (TW) 098112165

(51) Int. Cl. E06B 9/44

(52) U.S. Cl. 160/323.1

(57) ABSTRACT

A sunshade assembly includes a housing, a roller, and a screen. The housing defines a space therein, and is formed with a slot. The roller is disposed rotatably in the space and has small-diameter and large-diameter end parts. The screen is wound on the roller and has a free end portion, and short and long lateral end portions. The free end portion extends outwardly of the housing through the slot. The short and long lateral end portions are connected to the free end portion and are adjacent to the small-diameter and large-diameter end parts, respectively. The screen is operable between a retracted state, where the free end portion is adjacent to the roller, and an extended state, where the free end portion is distal from the roller so as to unwind the screen. The long lateral end portion has a length longer than that of the short lateral end portion when the screen is at the extended state.

### BACKGROUND OF THE INVENTION

1. Field of the Invention

The invention relates to a sunshade assembly, more particularly to a sunshade assembly adapted to be mounted on a side window of an automobile.

2. Description of the Related Art

Sunshades for an automobile are generally used in order to reduce the amount of sunlight entering into the automobile. Referring to FIG. 1, a conventional sunshade assembly 5 is shown to comprise a housing 51, an elongated roller 52 rotatably mounted in the housing 51, and a screen 53. The housing 51 is formed with a slot 511 extending along a lengthwise direction (L). The roller 52 extends along the lengthwise direction (L) with an uniform diameter, and has two opposite end parts 521.

The screen 53 is wound on the roller 52 and has a free end portion 533 and two lateral end portions 531 adjacent to the end parts 521 of the roller 52, respectively. The screen 53 is operable between a retracted state, where the free end portion 533 is adjacent to the roller 52, and an extended state, where the screen 53 extends outwardly of the housing 51 through the slot 511, and where the free end portion 533 is distal from the roller 52 in a transverse direction (T) transverse to the lengthwise direction (L), thereby unwinding the screen 53.

Further referring to FIG. 2, the sunshade assembly 5 is mounted on a side window 61 of an automobile 6. Due to the uniform diameter of the roller 52, the extended portion of the screen 53 will be maintained as a rectangle when the screen 53 is operated from the retracted state to the extended state. However, the side window 61 is shaped different from the screen 53 when the screen 53 is at the extended state. For example, the side window 61 has a shape of a trapezium as illustrated in FIG. 2. Therefore, when the screen 53 is at the extended state, it does not cover a front-upper portion 611 of the side window 61, and exceeds a rear-upper portion 612 of the side window 61. As a result, the conventional sunshade assembly 5 cannot provide a satisfactory sunshade effect and a pleasing visual aesthetic quality.

### SUMMARY OF THE INVENTION

Therefore, the object of the invention is to provide a sunshade assembly capable of alleviating the above drawbacks of the prior art.

Accordingly, a sunshade assembly for an automobile of the present invention comprises a housing, a roller, and a screen. The housing defines a space therein, and is formed with a slot that extends along a lengthwise direction, and that is in spatial communication with the space. The roller is disposed rotatably in the space of the housing, extends along the lengthwise direction, and has a small-diameter end part and a large-diameter end part that is opposite to the small-diameter end part in the lengthwise direction and that has a diameter larger than that of the small-diameter end. The screen is wound on the roller and has a free end portion, a short lateral end portion, and a long lateral end portion. The free end portion extends outwardly of the housing through the slot. The short lateral end portion is connected to the free end portion and is adjacent to the large-diameter end part of the roller. The long lateral end portion is opposite to the short lateral end portion in the lengthwise direction, is connected to the free end portion, and is adjacent to the small-diameter end part of the roller. The screen is operable between a retracted state, where the free end portion is adjacent to the roller, and an extended state, where the free end portion is distal from the roller in a transverse direction transverse to the lengthwise direction so as to unwind the screen. The long lateral end portion has a length longer than that of the short lateral end portion in the transverse direction when the screen is at the extended state.

### BRIEF DESCRIPTION OF THE DRAWINGS

Other features and advantages of the invention will become apparent in the following detailed description of the preferred embodiment with reference to the accompanying drawings, of which:

FIG. 1 is a perspective view of a conventional sunshade assembly;

FIG. 2 is a schematic view of the conventional sunshade assembly mounted on a side window of an automobile;

FIG. 3 is a fragmentary front view of a preferred embodiment of a sunshade assembly according to the present invention;

FIG. 4 is a fragmentary perspective view of a roller and a screen of the preferred embodiment;

FIG. 5 is a schematic front view of the roller and the screen of the preferred embodiment; and

FIG. 6 is a schematic view of the preferred embodiment mounted on a side window of an automobile.

### DETAILED DESCRIPTION OF THE PREFERRED EMBODIMENT

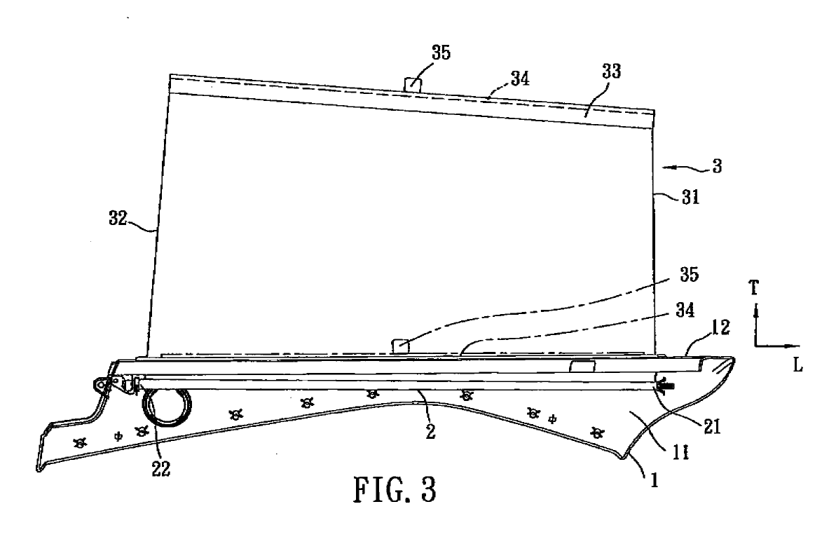

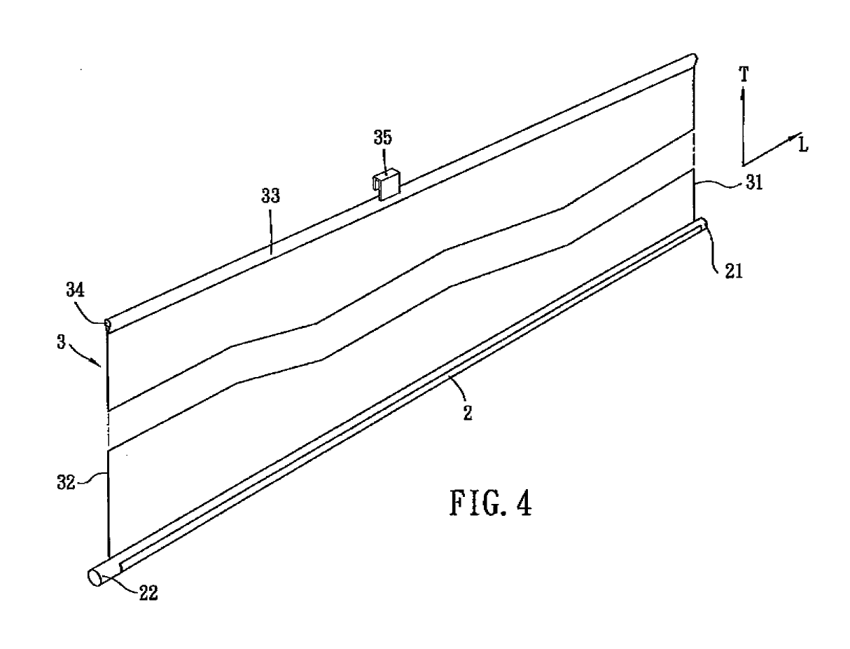

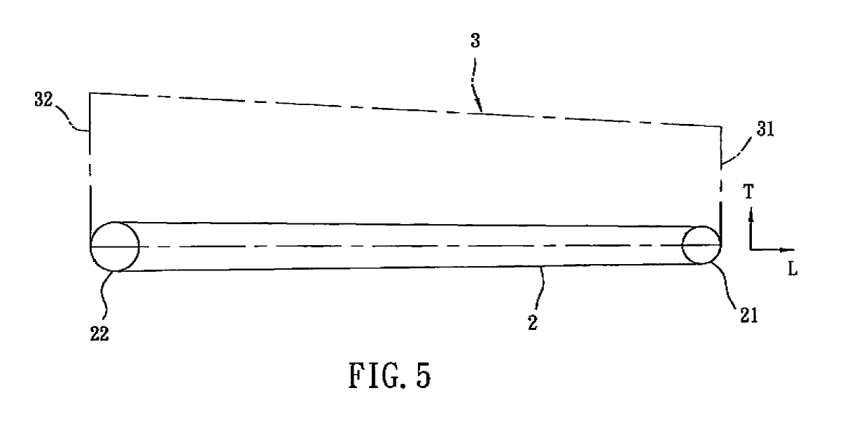

Referring to FIGS. 3 to 6, a preferred embodiment of the sunshade assembly according to the present invention comprises a housing 1, a roller 2, and a screen 3.

The housing 1 defines a space 11 therein and is formed with a slot 12 that extends along a lengthwise direction (L) and that is in spatial communication with the space 11. The roller 2 is disposed rotatably in the space 11 of the housing 1, extends along the lengthwise direction (L), and has a small-diameter end part 21 and a large-diameter end part 22 that is opposite to the small-diameter end part 21 in the lengthwise direction (L) and that has a diameter larger than that of the small-diameter end part 21. The diameter of the roller 2 decreases gradually from the large-diameter end part 22 to the small-diameter end part 21.

The screen 3 is made of a sun blocking, is wound on the roller 2, and has a free end portion 33, a short lateral end portion 31, and a long lateral end portion 32. The free end portion 33 extends outwardly of the housing 1 through the slot 12. The short lateral end portion 31 is connected to the free end portion 33 and is adjacent to the small-diameter end part 21 of the roller 2. The long lateral end portion 32 is connected to the free end portion 33, is opposite to the short lateral and portion 31 in the lengthwise direction (L), and is adjacent to the large-diameter end part 22 of the roller 2. The screen 3 is operable between a retracted state, where the free end portion 33 is adjacent to the roller 2 as illustrated in phantom lines in FIG. 3, and an extended state, where the free end portion is distal from the roller 2 in a transverse direction (T) transverse to the lengthwise direction (L) so as to unwind the screen 3 as illustrated in solid lines in FIG. 3. The long lateral end portion 32 of the screen 3 has a length longer than that of the short lateral end portion 31 in the transverse direction (T) when the screen 3 is at the extended state.

The roller 2 may be designed to be biased by a torsion spring (not shown) to rotate so as to move the screen 3 toward the retracted state. Since the feature of the present invention does not reside in the specific construction of the torsion spring, which is known in the art, further details of the same are omitted herein for the sake of brevity. The screen 3 further has a side strip 34 and a handle 35. The side strip 34 is mounted to the free end portion 33 of the screen 3 and extends along the lengthwise direction (L) so that the screen 3 can be extended tautly. The handle 35 is accessibly provided on the side strip 34 for operating the screen 3 to the extended state.

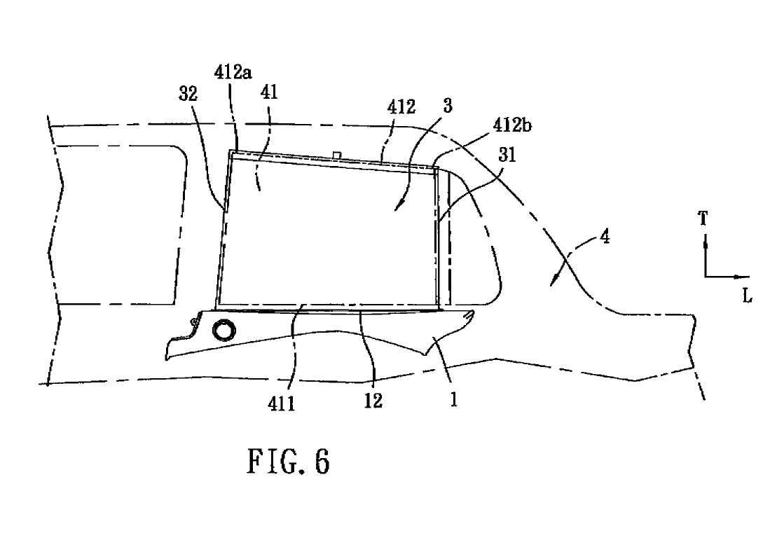

As shown in FIG. 6, the sunshade assembly is mounted on a side window 41 of an automobile 4. The side window 41 has a shape of a trapezium, and includes a bottom side 411, and an upper side 912 that is inclined relative to the bottom side 411. As such, a front end 412a of the upper side 412 is at a position higher than a rear end 412b thereof. The housing 1 of the sunshade assembly is secured under the bottom side 411 of the side window 41, with the slot 12 of the housing 1 facing toward the bottom side 411.

When the screen 3 is moved from the retracted state to the extended state, since the long lateral end portion 32 of the screen 3 is longer than the short lateral end portion 31 in the transverse direction (T), the short and long lateral end portions 31, 32 have distal ends aligned respectively with the front and rear ends 412a, 412b of the upper side 412. Therefore, the screen 3 has a profile when at the extended state conforming with that of the side window 41 of the automobile 4.

The screen 3 of the sunshade assembly can be maintained at any desired position when being moved from the retracted state to the extended state. When the handle 35 is pushed toward the slot 12 of the housing 1, a portion of the screen 3 that moves into the housing 1 through the slot 12 is simultaneously wound on the roller 2. Since the feature of the present invention does not reside in the operation of the screen 3 between the extended state and the retracted state, further details of the same are omitted herein for the sake of brevity.

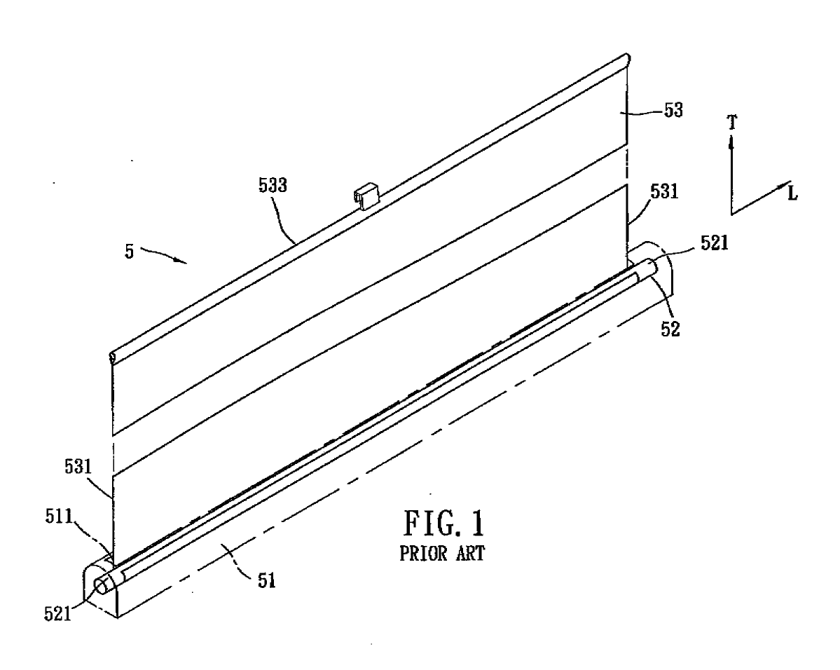

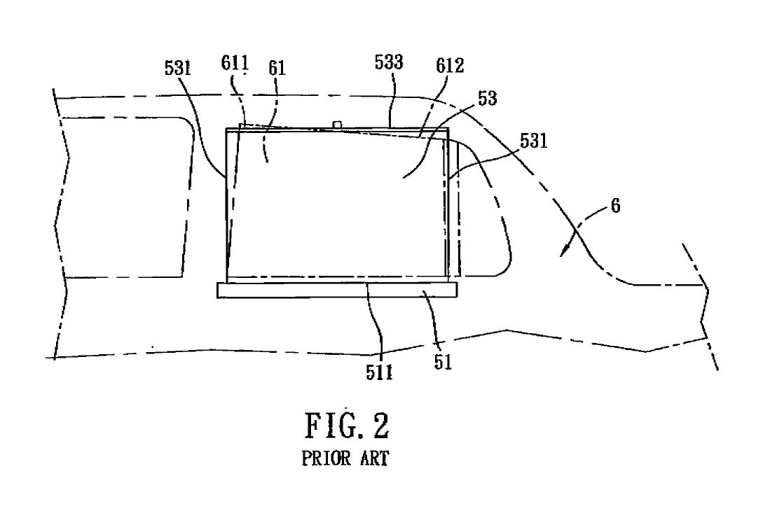

Therefore, compared to the conventional sunshade assembly 5 as illustrated in FIGS. 1 and 2, the screen 3 of the sunshade assembly of this invention at the extended state is shaped to conform with that of the side window 41 of the automobile 9, thus providing a satisfactory sunshade effect and improving visual aesthetic quality of the sunshade assembly.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade assembly for an automobile comprising:
a housing defining a apace therein, and formed with a slot that extends along a lengthwise direction and that is in spatial communication with said space;
a roller disposed rotatably in said space of said housing, extending along the lengthwise direction, and having a small-diameter end part and a large-diameter end part that is opposite to said small-diameter end part in the lengthwise direction and that having a diameter larger than that of said small-diameter end part; and
a screen wound on said roller and having a free end portion that extends outwardly of said housing through said slot, a short lateral end portion that is connected to said free end portion and that is adjacent to said small-diameter end part of said roller, and a long lateral end portion that is connected to said free end portion, that is opposite to said short lateral end portion in the lengthwise direction, and that is adjacent to said large-diameter end part of said roller, said screen being operable between a retracted state, where said free end portion is adjacent to said roller, and an extended state, where said free end portion is distal from said roller in a transverse direction transverse to the lengthwise direction so as to unwind said screen, said long lateral end portion has a length longer than that of said short lateral end portion in the transverse direction when said screen is at the extended state.

2. The sunshade assembly as claimed in claim 1, wherein said screen further has a side strip that is mounted to said free end portion of said screen and that extends along the lengthwise direction.

3. The sunshade assembly as claimed in claim 2, wherein said screen further has a handle provided on said side strip.
